(19) United States
(12) Patent Application Publication
(10) Pub. No.: US 2018/0009499 A1
(43) Pub. Date: Jan. 11, 2018

(54) Bicycle Frame

(71) Applicant: Canyon Bicycles GmbH, Koblenz (DE)

(72) Inventors: Alexander Forst, Koblenz (DE); Lukas Schuchnigg, Koblenz (DE)

(21) Appl. No.: 15/642,592

(22) Filed: Jul. 6, 2017

(30) Foreign Application Priority Data
Jul. 7, 2016 (DE) 20 2016 004 206.9

(51) Int. Cl. B62K 3/04; B62K 19/32; B62K 19/34; B62K 19/36

(52) U.S. Cl. CPC B62K 3/04; B62K 19/36; B62K 19/32; B62K 19/34; B62K 2700/50

(57) ABSTRACT

A bicycle frame including a down tube, a saddle tube, and a top tube is disclosed. The top tube comprises a first section which, starting from the saddle tube, is oriented in an ascending orientation. Thereby, a space between the down tube, the saddle tube, and the top tube is enlarged, so that the bicycle frame can be carried on a person's shoulder in a more convenient manner.

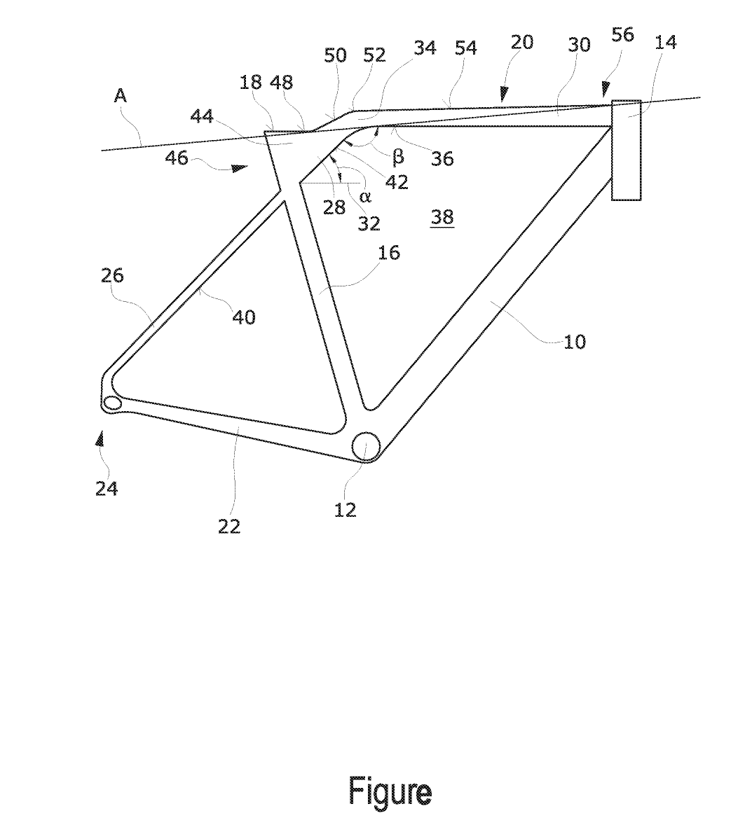

### CROSS-REFERENCE TO RELATED APPLICATION

This application claims priority to German Utility Model Application No. 20 2016 004 206.9 filed Jul. 7, 2016, the disclosure of which is hereby incorporated in its entirety by reference.

### BACKGROUND OF THE INVENTION

### Field of the Invention

The present invention relates to a bicycle frame, particularly a frame for a racing bicycle. The bicycle frame of the invention is suited particularly suited for a cross bike, especially a cyclo-cross bike.

### Description of Related Art

Occasionally, it is required to carry a bicycle. Particularly cyclo-cross bikes have to be carried on the open terrain time and again. Particular demands are posed on cross bikes which are used in contests such as e.g. in cyclo-cross bike circuits. Cross bikes are racing bicycles of a special design that are suited particularly also for contests on the open terrain. For this reason, particularly cross bikes have to be carried occasionally. Normally, for carrying such a bicycle, the top tube of the bicycle frame is placed on the cyclist's shoulder. Due to the frame design of the bicycle frame which is configured as a diamond frame, the handling of the bicycle while carrying it is difficult.

It is an object of the invention to provide a bicycle frame, particularly a bicycle frame for cross bikes, which allows for better handling while being carried. In this respect, it is preferred that the regulations of the UCI are complied with.

According to the invention, the above object is achieved by the features described herein.

### SUMMARY OF THE INVENTION

The bicycle frame according to the invention comprises a down tube, a top tube and a saddle tube. The down tube is arranged between a bottom bracket and a steerer tube serving to receive the fork stem of the front wheel fork. Also the saddle tube is connected the bottom bracket. Optionally, this connection can also be an indirect one so that the saddle tube is connected to the down tube e.g. near the bottom bracket. The saddle tube is oriented in an upward direction, wherein its open top end serves for receiving the saddle support tube carrying the saddle. The top tube is connected to the saddle tube and the steerer tube. According to the invention, the top tube—as compared to conventional top tubes of such bicycle frames, particularly bicycle frames for cross bikes—is arranged at a higher level at least in region of the connection to the saddle tube. For this purpose, the top tube comprises, in a first section connected to the saddle tube, an angle relative to the horizontal line of more than 30°, preferably more than 40° and with particular preference more than 60°. In this context, the horizontal line is to be understood in the sense of a plane or line extending parallel to a horizontal support surface of an assembled bicycle. According to the invention, the top tube in its first section is arranged in an ascending orientation starting from the saddle tube. Thereby, it is possible to realize a higher arrangement of the top tube in the first section of the top tube. This has the effect that the area enclosed within the top tube, the down tube and the saddle tube is enlarged. Thereby, placing the bicycle on the shoulder is facilitated.

According to an alternative embodiment of the bicycle frame, an angle between the first section of the top tube connected to the saddle tube and a second section of the top tube adjoining the first section, is in the range from 120° to 160° and particularly from 130° to 150°. Herein, the second section of the top tube is that section which adjoins the first section in the direction toward the steerer tube and preferably is connected to the latter, provided that the top tube does not comprise a further section. Also in this embodiment, the area between the top tube, the down tube and the saddle tube is enlarged, thus making it easier to place the bicycle on the shoulder.

Preferably, there is provided a combination of the two above embodiments of the bicycle frame so that the top tube first rises in a first section and then extends at the corresponding angle in the direction toward the steerer tube.

According to a first preferred embodiment, a straight line can be arranged or drawn between the steerer tube and the saddle tube, said line always extending within the top tube. In so far, the degree of the angled orientation of the individual sections of the top tube is limited. This, particularly, has the benefit of a good force take-up and transmission between the individual components of the bicycle frame. Further, this will guarantee conformity with the UCI regulations. Preferably, when seen in lateral view, the corresponding line extends, starting at the saddle tube, in an ascending orientation in the direction toward the steerer tube. Further, it can be provided that said line touches, or intersects with, a connection region between the top tube and the steerer tube.

With particular preference, the first section of the top tube has a length of at least 5 cm, preferably at least 7 cm and with particular preference at least 10 cm. Further, it is preferred that the first section of the top tube is shorter than 20 cm, preferably shorter than 17 cm and with particular preference shorter than 15 cm. In correspondence thereto, suitable frame geometries can be realized. Herein, the first section is particularly the first section of the top tube between the saddle tube and the region in which the angle relative to the second section of the top tube is provided.

Preferably, the second section of the top tube is straight-lined and is indirectly or directly connected to the steerer tube. Thus, according to a preferred embodiment, the second section does comprise an angle change in the longitudinal direction.

With particular preference, the second section of the top tube is substantially horizontal. Alternatively, the second section of the top tube can take a slightly ascending or descending course in the direction toward the steerer tube. It is preferred that the second section of the top tube extends at an angle of less than 20°, particularly less than 10° relative to a horizontal line.

According to a further, particularly preferred embodiment, an upper end of the saddle tube is arranged below an upper edge in the transition region between the first section and the second section of the top tube. The upper end of the saddle tube is the end of the saddle tube opposite to the bottom bracket, serving to receive the saddle support tube. The first and the second section of the top tube, when seen in lateral view, comprise an upper edge. In said transition region, this edge—when seen laterally—is thus the highest point of the first section of the top tube because, starting at the saddle tube, the top tube has an ascending orientation.

Further, it is preferred that, between an upper end of the saddle tube and the first section of the top tube, a connection element is provided. The connection element closes the intermediate space between the upper end of the saddle tube and the first section of the top tube, preferably completely. Thereby, particularly, the stiffness of the frame in this region can be improved. Particularly, when seen in lateral view, one edge of the upper end of the saddle tube merges in a stepless manner into an upper edge of the connection element, and said upper edge in turn merges in a stepless manner into the upper edge of the transition region between the first and the second section of the top tube.

Further, the bicycle frame comprises seat stays. These extend from the rear dropout ends of the bicycle frame which are provided to receive the rear wheel, to the saddle tube. According to a particularly preferred embodiment, the seat stays merge into the first section of the top tube. Thereby, a good force transmission can be realized. In this regard, it is especially preferred that a lower edge of the seat stays merges into a lower edge of the first section of the top tube, particularly in a straight-lined manner, i.e. without a change of angle.

When the bicycle frame is to be shouldered, the bicycle frame can first be placed on the shoulder by the first section of the top tube. Because of the ascending design of the first section, the bicycle frame will automatically slide toward the rear so that the bicycle frame will come to rest on the shoulder in the transition region between the first and the second section. For this purpose, according to a particularly preferred embodiment, the transition region is of a curved shape. Particularly, the bottom side of the transition region, i.e. the side facing toward the down tube, is concave and preferably does not comprise edges and the like. Thereby, the carrying comfort is improved.

In all of the above described embodiments, the cross sectional shapes of the individual frame elements can provided in various manners and in accordance with the design.

A particular advantage of the bicycle frame of the invention resides in that, by such a design of the top tube, while achieving an improved handling for carrying the bicycle, the currently valid UCI guidelines are complied with. This is realized while at the same time using a “normal length saddle tube”. In its dimensions, a “normal-length saddle tube” corresponds to the saddle tube of a racing bicycle.

As provided by the invention, the bicycle frame is particularly suited for a cyclo-cross bike. For this use, it is particularly preferred according to the invention that, when carried on the shoulder, the entire bicycle is supported in such a manner that the front wheel relative to a horizontal line is arranged slightly lower or, respectively, the bicycle is slightly inclined in forward direction. In this manner, the carrying comfort is considerably improved. A complete bicycle of this design normally comprises, apart from the bicycle frame of the invention, the usual required components such as e.g. the running wheels, the handlebar, the saddle, the gearing system, the brakes and the like. By such a balancing orientation of the bicycle while carrying it, the carrying is rendered distinctly easier.

### BRIEF DESCRIPTION OF THE DRAWING

A full and enabling disclosure of the present invention, including the best mode thereof, enabling one of ordinary skill in the art to carry out the invention, is set forth in greater detail in the following description, including reference to the accompanying drawing in which the sole FIGURE shows a bicycle frame according to the invention in lateral view.

### DESCRIPTION OF THE INVENTION

The bicycle frame comprises a down tube 10 which is arranged between a bottom bracket 12 and a steerer tube 14. The steerer tube 14 serves for receiving the fork stem of the front wheel fork. The bicycle frame further comprises a saddle tube 16 which, starting from the bottom bracket 12, extends upward. At an upper end 18, the saddle tube 16 is open and serves for receiving the saddle support tube supporting the saddle. Further, the bicycle frame comprises a top tube 20 which is connected to saddle tube 16 and steerer tube 14. Two mutually opposite chain stays 22 are connected to bottom bracket 12 and a dropout end 24. Further, two saddle stays 26, again arranged mutually opposite, are provided which, starting from the dropout end 24 for receiving the rear axis of the rear wheel, extend to saddle tube 16.

Top tube 20 comprises a first section 28 and an adjoining second section 30 extending substantially horizontally. Starting from saddle tube 16, the first section 28 is of a slightly ascending orientation. Thus, section 28 comprises an angle α relative to a horizontal line 32. Said angle α is preferably larger than 30° and more preferably larger than 40°.

The first section 28 merges into a transition region 34 running into the second section 30. A bottom edge 36 of top tube 20 is bent, particularly in a concave shape, within said transition region 34.

Between the first section 28 and the second section 30, there is formed an angle β in the range from 120° to 160, particularly 120° to 140°.

By this frame geometry, an area 38 delimited by down tube 10, saddle tube 16 and top tube 20 is enlarged so that the carrying comfort is improved.

A bottom edge 40 of the seat stays 26 merges in a stepless manner into a bottom edge 42 of the first section 28.

Further, a connection element 44 is arranged between the saddle tube 16 and the first section 28 of top tube 20. By said connection element 44, the area of an upper end 46 of saddle tube 16 and of the first section 28 is filled out, preferably completely so. Further, an upper edge formed by the upper end 18 of saddle tube 16 is designed in such a manner that it merges steplessly both into an upper edge 48 of connection element 44 and into an upper edge 50 of first section 28. The upper edge 50 of first section 28 merges with a convex curvature into the upper edge 52 of transition region 34 and then into the upper edge 54 of second section 30.

Particularly in order to ensure the UCI conformity of the bicycle frame, it can be provided that, as seen in lateral view, a straight line A can be passed through the top tube 20 in such a manner that, between steerer tube 14 and saddle tube 16, said line always extends within the top tube 20. Thus, the line A extends within the first section 28, within the transition region 34 as well as within the second section 30 of top tube 20. In its embodiment illustrated herein, line A contacts a connection area 56 between the second section 30 of top tube 20 and the steerer tube 14. Further, line A contacts an inner side of top tube 20 in the transition region 34 between first section 28 and second section 30.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A bicycle frame comprising:
a down tube arranged between a bottom bracket and a steerer tube,
a saddle tube connected to the bottom bracket, and
a top tube arranged between the saddle tube and the steerer tube,
wherein the top tube comprises, in a first section connected to the saddle tube, an angle α relative to the horizontal line of more than 30°, and/or between the first section of the top tube connected to the saddle tube and a second section of the top tube adjoining the first section, an angle β of from 120° to 160°.

2. The bicycle frame according to claim 1, wherein the top tube comprises, in a first section connected to the saddle tube, an angle α relative to the horizontal line of more than 60°.

3. The bicycle frame according to claim 1, wherein between the first section of the top tube connected to the saddle tube and the second section of the top tube adjoining the first section defines angle β of from 130° to 150°.

4. The bicycle frame according to claim 1, wherein, between the steerer tube and the saddle tube, a straight line can be arranged which extends internally of the top tube.

5. The bicycle frame according to claim 4, wherein said line contacts a connecting region between the top tube and the steerer tube.

6. The bicycle frame according to claim 1, wherein the first section is longer than 5 cm.

7. The bicycle frame according to claim 1, wherein the first section is shorter than 20 cm.

8. The bicycle frame according to claim 1, wherein the second section is straight-linear and is connected to the steerer tube.

9. The bicycle frame according to claim 1, wherein the second section is oriented substantially horizontally with respect to the steerer tube.

10. The bicycle frame according to claim 1, wherein the second section is arranged in a slightly ascending orientation in the direction toward the steerer tube.

11. The bicycle frame according to claim 1, wherein the second section is arranged in a slightly descending orientation in the direction toward the steerer tube.

12. The bicycle frame according to claim 10, wherein the second section comprises an angle relative to the horizontal line of less than 20°.

13. The bicycle frame according to claim 10, wherein the second section comprises an angle relative to the horizontal line of less than 10°.

14. The bicycle frame according to claim 1, wherein an upper end of the saddle tube is arranged below an upper edge in the transition region between the first section and the second section of the top tube.

15. The bicycle frame according to claim 1, wherein, between an upper end of the saddle tube and the first section of the top tube, a connection element is provided which fills the intermediate space between the upper end and the first section.

16. The bicycle frame according to claim 1, wherein, between a dropout end and the saddle tube, seat stays are arranged which merge into the first section of the top tube.

17. The bicycle frame according to claim 16, wherein a bottom edge of the seat stays merges, preferably in a straight-lined manner, into a bottom edge of the first section of the top tube.
